(19) United States
(12) Patent Application Publication
(10) Pub. No.: US 2026/0005444 A1
(43) Pub. Date: Jan. 1, 2026

(54) DEVICES TO DIRECT THE PATH OF ELECTROMAGNETIC RADIATION

(71) Applicant: CORNING INCORPORATED, CORNING, NY (US)

(72) Inventors: Hyeng-cheul Choi, Seoul (KR); Byounggwan Kang, Seoul (KR); Choonkon Kim, Cheonan-si (KR); Hyung Soo Moon, Gangnam-gu (KR)

(21) Appl. No.: 18/992,309

(22) PCT Filed: Aug. 8, 2023
(86) PCT No.: PCT/KR2023/011645

§ 371 Date: Jan. 8, 2025

Related U.S. Application Data
(60) Provisional application No. 63/397,002, filed on Aug. 11, 2022.

(51) Int. Cl. H01Q 15/14

(52) U.S. Cl. CPC H01Q 15/147

(57) ABSTRACT

One or more devices for directing the path of electromagnetic radiation are described. The one or more devices include a substrate comprising a glass material. The substrate also includes a pattern of a metallic material formed on at least a first surface of the substrate. The pattern includes features that cause electromagnetic radiation incident on the substrate to be phase shifted.

### TECHNICAL FIELD

### Cross-Reference To Related Applications

This application claims the benefit of priority under 35 U.S.C. § 119 of U.S. Provisional Application Ser. No. 63/397,002 filed on Aug. 11, 2022, the content of which is relied upon and incorporated herein by reference in its entirety.

Implementations are directed to devices that direct the path of electromagnetic radiation. At least some implementations relate to techniques for changing the direction of electromagnetic radiation using devices that have patterns of metallic materials disposed on a glass-containing substrate.

### BACKGROUND ART

The path of electromagnetic radiation can be modified to direct the electromagnetic radiation to a location of one or more receiver devices. Techniques for designing and fabricating devices that accurately direct electromagnetic radiation to receiver devices while minimizing signal loss may be desirable.

### DISCLOSURE OF INVENTION

### Technical Problem

One or more implements are related to provide techniques for designing and fabricating devices that accurately direct electromagnetic radiation to receiver devices while minimizing signal loss.

### Solution to Problem

One or more implements are related to provide techniques for designing and fabricating devices that accurately direct electromagnetic radiation to receiver devices while minimizing signal loss.

One or more implements include a device comprising: one or more substrates, individual substrates of the one or more substrates comprising a glass material and the substrate including a first surface and a second surface disposed opposite the first surface; and a layer of metal disposed on the first surface according to a pattern that includes a number of elements, wherein electromagnetic radiation incident on the first surface at a first angle is redirected at a second angle, and the electromagnetic radiation has a frequency of at least twenty gigahertz (GHz).

One or more implements include a communications device comprising: a first substrate comprised of a glass material and having a layer of metal disposed on at least one surface of the first substrate according to a pattern that includes a number of elements, wherein electromagnetic radiation incident on the at least one surface at a first angle is redirected at a second angle, and the electromagnetic radiation has a frequency of at least twenty gigahertz (GHz); a second substrate comprised of a glass material and having an additional layer of metal disposed on at least one surface of the second substrate according to the pattern, wherein electromagnetic radiation incident on the at least one surface at a first additional angle is redirected at a second additional angle; and a gap disposed between the first substrate and the second substrate, wherein the gap has a thickness of from 1.5 mm to 4 mm.

One or more implements include a process comprising: providing a substrate comprising a glass material having a Young's modulus of at least 30 GPa, a thickness from 0.2 mm to 0.6 mm, and a relative permittivity from 4.0 F/m to 6.0 F/m; forming a first pattern on a first surface of the substrate by depositing a first layer of metal on the first surface; forming a second pattern on a second surface of the substrate by depositing a second layer of the metal on the second surface; coupling the substrate with an additional substrate comprising the glass material such that a gap is disposed between the substrate and the additional substrate, wherein the gap has a thickness of from 1.5 mm to 4 mm; and producing a device that comprises a plurality of substrates that include at least the substrate and the additional substrate, wherein the device redirects the path of electromagnetic radiation incident on the device by at least 25 degrees, and wherein the electromagnetic radiation has frequencies of at least 20 GHz.

### BRIEF DESCRIPTION OF DRAWINGS

FIG. 1 illustrates an environment that includes a source of electromagnetic radiation and a communication device that includes a substrate to direct the path of the electromagnetic radiation, in accordance with one or more implementations.

FIG. 2 illustrates an example partial cross-section view of a substrate that includes a number of features to direct the path of electromagnetic radiation, according to one or more implementations.

FIG. 3 illustrates an example device that includes multiple substrates to direct the path of electromagnetic radiation, according to one or more implementations.

FIG. 4 illustrates a flowchart of an example process to produce a device that directs the path of electromagnetic radiation, in accordance with one or more implementations.

FIG. 5A illustrates an orthogonal view of unit cells of a metasurface of a transmitarray to direct the path of electromagnetic radiation, according to one or more implementations.

FIG. 5B illustrates a top view of the metasurface of the transmitarray to direct the path of electromagnetic radiation, according to one or more implementations.

FIG. 6 illustrates a device including multiple metasurfaces to direct the path of electromagnetic radiation, according to one or more implementations.

FIG. 7 illustrates a measurement system to determine an amount of phase shift produced in response to electromagnetic radiation being incident on the device shown in FIG. 6, according to one or more implementations.

FIG. 8 illustrates measurements of gain without and without the device of FIG. 6.

FIG. 9 illustrates reflection loss for a device having a glass substrate with a number of unit cells formed on the glass substrate in relation to the path length of a pattern included in the unit cell.

### BEST MODE FOR CARRYING OUT THE INVENTION

The following description and the drawings sufficiently illustrate specific implementations to enable those skilled in the art to practice them. Other implementations may incorporate structural, logical, electrical, process, and other changes. Portions and features of some implementations may be included in, or substituted for, those of other implementations. Implementations set forth in the claims encompass all available equivalents of those claims.

Various devices are currently used to direct the path of electromagnetic radiation across a number of frequency ranges. For example, beam steering using antennas can modify the path of electromagnetic radiation in wireless communication systems. Beam steering can dynamically adjust the path of electromagnetic radiation based on the location of an antenna and based on a location of a receiving device that is a target for the electromagnetic radiation. As the location of the antenna changes and/or as the location of a receiving device changes, the antenna can direct the electromagnetic radiation to the receiving device. In one or more examples, an antenna may be moved due to environmental conditions, such as wind, or a device housing the antenna may be in motion, such as a satellite. Additionally, a receiving device can be a mobile computing device that is in motion as a user of the mobile computing device changes location. By adjusting the path of the electromagnetic radiation using beam steering techniques, reception of the electromagnetic radiation at the receiving device can be improved. In at least some examples, the use of beam steering can cause an increase in signal strength that results in a higher signal-to-interference ratio. As a result, at least one of the range of a communications system or a capacity of the communications system can increase.

Transmitarrays, reflectarrays, and reconfigurable intelligent surfaces can be used to direct the path of electromagnetic radiation. Transmitarrays can change an angle of transmission of incident electromagnetic radiation to retransmit the incident electromagnetic radiation at a different path according to a different angle. Transmitarrays can include a number of unit cells that include patterns of metallic materials or other conductive materials that redirect the incident electromagnetic radiation according to a different angle other than the initial angle of incidence. The patterns of conductive material formed on the transmitarrays can include at least one of metasurfaces or frequency selective surfaces (FSS).

Reflectarrays modify the angle of incidence of electromagnetic radiation according to Snell's law by reflecting back the incident electromagnetic radiation along a different path than the angle of incidence. Reflectarrays include surfaces that do not retransmit the electromagnetic radiation through the surfaces of the reflectarray at a different angle, but direct the electromagnetic radiation back toward the source of the electromagnetic radiation at a different angle. The reflection of electromagnetic radiation that is caused by the reflectarray takes place for a relatively broad range of frequencies. In contrast, transmitarrays are designed to retransmit electromagnetic radiation for a relatively narrow range of frequencies to minimize signal loss due to reflection.

Reconfigurable intelligent surfaces (RISs) include an array of elements that are configurable individually or as groups to control the scattering, absorption, reflection, and/or diffraction properties of the RIS with respect to incident electromagnetic radiation. The elements of RISs can include patterns of circuits that can modify the amplitude, implement delays, and/or change polarization characteristics of incident electromagnetic radiation. A controller can be used to modify the features of the elements of an RIS, such as modifying impedance, to change the response curves of one or more of the elements.

In existing technologies, organic substrates have been used to reduce signal loss when changing the path of incident electromagnetic radiation. The organic substrates can include or be formed from a number of organic materials. In one or more examples, the organic substrates can contain polydimethylsiloxane (PDMS). Additionally, the organic substrates can contain polytetrafluoroethylene (PTFE). These organic substrates can have relatively low relative permittivities, such as less than 6. Relative permittivities can correspond to the ratio of the permittivity of a material with respect to the permittivity of a vacuum. Organic substrates used to direct the path of incident electromagnetic radiation can also be relatively thin, such as on the scale of tens of micrometers or less to minimize signal loss.

However, as electromagnetic radiation frequencies have increased to carry communications signals according 5G and 6G technologies, the signal loss of these organic substrates has increased. For example, as frequencies of electromagnetic radiation increase, the path of current propagating along conductive patterns that are disposed on the substrates increases resulting in increased signal loss. In various examples, in situations where the surface roughness of the substrates approaches or is greater than the thickness of the metallic layers used to form the conductive patterns, signal loss increases based on the length of the propagation path of current traveling through the conductive patterns. The surface roughness of organic substrates can also result in inaccuracies of the patterns formed on the organic substrates. Variations in the patterns of conductive materials can result in phase errors that can decrease the accuracy of the re-transmission of electromagnetic radiation incident on the substrates. The ability to minimize surface roughness of the organic substrates is limited and devices that include these substrates to direct the path of electromagnetic radiation can have limited effectiveness at various frequency ranges due to loss of signal strength and phase error for electromagnetic radiation that is re-transmitted by these devices.

Other design considerations for devices that redirect the path of electromagnetic radiation are related to the thickness of the substrates and the gap between the substrates. Reducing the thickness of organic substrates used in devices that redirect the path of electromagnetic radiation can lead to a reduction in mechanical strength of these organic substrates. The reduced strength of these thinner organic substrates can result in unintended paths for electromagnetic radiation incident on the organic substrates due to bending or warping of the organic substates. In some cases, support structures can be included in organic substrates to increase overall mechanical strength of the substrates, but the support structures cause an increase of the overall dielectric constant of the substrate. Thus, signal loss can increase resulting in reduced transmission performance of devices that include these organic substrates.

According to one or more implementations herein, devices that include substrates comprised of a glass material are used to direct the path of electromagnetic radiation. At least 50% by weight of the substrates can comprise a glass material. The substrates can have a pattern of conductive material disposed on at least one surface of the substrates. The pattern of conductive material can cause the path of electromagnetic radiation incident on the pattern to be modified, such as by reflecting the electromagnetic radiation back toward a source or modifying the angle of transmission. In various examples, the pattern of conductive material can modify a path of electromagnetic radiation having frequencies of at least 3 gigahertz (GHz). The glass-containing substrates can have a relatively low relative permittivity to minimize signal loss. For example, the glass-containing substrates can have relative permittivities no greater than 6 Farads/meter. In addition, the glass-containing substrates can be relatively thin while maintaining sufficient mechanical strength. To illustrate, the glass-containing substrates can have thickness no greater than 0.6 mm with a Young's Modulus of at least 30 gigapascals (GPa) without any additional support structures included in the glass-containing substrates.

The glass-containing substrates can also have a lower surface roughness than the surface roughness of substrates containing organic materials. Surface roughness can correspond to deviations in the surface in the direction of a vector normal to the surface from its ideal form. In one or more examples, the surface roughness can correspond to a mean value for roughness measured on one or more sections of a surface. In various examples, the glass-containing substrates can have a surface roughness of no greater than 0.5 micrometers. In one or more examples, the surface roughness of the glass-containing substrates can result in a phase error of no greater than 5 degrees.

In various examples, the characteristics of devices that direct the path of electromagnetic radiation and include one or more glass-containing substrates can be configured to minimize signal loss due to reflection in scenarios where the devices comprise transmitarrays. For example, the relative permittivities of the glass-containing substrates, the thickness of the glass-containing substrates, and the thickness of gaps between the glass-containing substrates can be designed such that a total reflection coefficient is no greater than 0.7. In one or more examples, the thickness of the gap between substrates can be based on the relative permittivity of the glass-containing substrates and the thickness of the glass-containing substrates in order to minimize the total reflection coefficient. In one or more additional examples, for a given gap between the glass-containing substrates, a thickness of the glass-containing substrates and/or the relative permittivity of the glass-containing substrates can be determined in order to minimize the total reflection coefficient. By minimizing the total reflection of implementations of devices described herein that comprise glass-containing substrates, signal loss is also minimized.

By using glass-containing substrates having at least a minimum value of one or more strength characteristics and having less than a specified amount of surface roughness, implementations of devices described herein that direct the path of electromagnetic radiation can have reduced signal loss and reduced phase error with respect to frequencies of at least 3 GHz in relation to devices that comprise organic substrates. Additionally, by tuning the parameters of relative permittivity of the glass-containing substrates, the thickness of the glass containing substrates, and the thickness of the gap between substrates of the devices that comprise the glass-containing substrates, the total reflection coefficient can also be minimized, and signal loss can be reduced in relation to devices that include organic substrates.

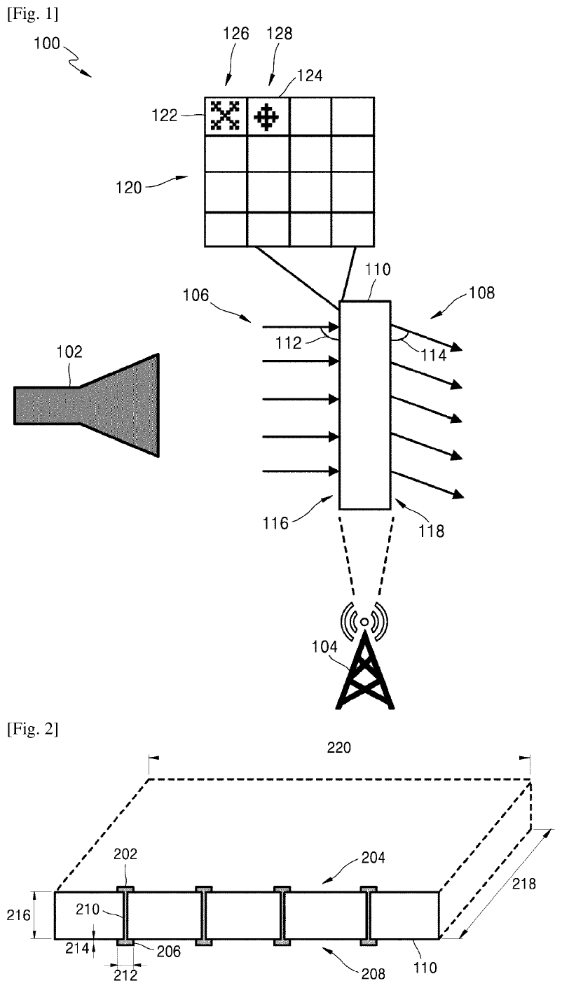

FIG. 1 illustrates an environment 100 that includes a source 102 of electromagnetic radiation and a communication device 104 that includes one or more substrates to direct the path of the electromagnetic radiation, in accordance with one or more implementations. The source 102 can be a device or included in a device that transmits electromagnetic radiation. In one or more examples, the source 102 can encode informationin the electromagnetic radiation. For example, the source 102 can include a computing device that is part of a communication system. To illustrate, the source 102 can include a user device. In various examples, the source 102 can be a user device that can have a fixed location or mobile and can refer to any equipment that can communicate with the communication device 104 to transmit and receive data and/or control information thereto or therefrom. For example, the source 102 can comprise a terminal, a terminal equipment, a mobile station (MS), a mobile terminal (MT), a user terminal (UT), a subscriber station (SS), a wireless device, a handheld device, a smart phone, a tablet computing device, a laptop computing device, a mobile gaming device, a smart watch, one or more additional user computing devices, or the like. Additionally, the source 102 can include another component of a communication system, such as a relay, a base station, a router, a switch, one or more combinations thereof, and the like.

In various examples, the communication device 104 can include a base station. A base station can include a device or system that communicates with user devices and/or other base stations. In at least some examples, a location of a base station can be fixed. A base station can communicate data and control information by sending and/or receiving electromagnetic radiation with respect to at least one of user devices or other base stations. In one or more illustrative examples, the communication device 104 can correspond to a Node B, an evolved-Node B (eNB), a next generation Node B (gNB), a sector, a site, a base transceiver system (BTS), an access pint (AP), a relay node, a remote radio head (RRH), a radio unit (RU), a small cell, or the like. The communication device 104 can also correspond to an area or function that is covered by a base station controller (BSC) in CDMA, a Node-B in WCDMA, an eNB in LTE, a gNB or sector (site) in 5G, and the like, and can cover various coverage areas such as megacell, macrocell, microcell, picocell, femtocell, relay node, RRH, RU, and small cell communication ranges.

In one or more examples, the source 102 and the communication device 104 can be part of a wireless communication system. In one or more illustrative examples, the wireless communication system can include and/or implement a cellular network, such as a 5th generation wireless (5G) system, a long term evolution (LTE) system, an LTE-advanced system, a code division multiple access (CDMA) system, or a global system for mobile communications (GSM), or may be a wireless local area network (WLAN) system or any other wireless communication system. Although a wireless communication system that includes the source 102 and the communication device 104 may be described mainly with reference to a wireless communication system using a cellular network, it will be understood that example implementations of the disclosure are not limited thereto.

A wireless communication network that includes the source 102 and the communication device 104 can support communication between multiple user devices by sharing available network resources. For example, information can be communicated between user device using one or more multiple access schemes, such as code division multiple access (CDMA), frequency division multiple access (FDMA), time division multiple access (TDMA), orthogonal frequency division multiple access (OFDMA), single carrier frequency division multiple access (SC-FDMA), OFDM-FDMA, OFDM-TDMA, and OFDM-CDMA. In one or more illustrative examples, a user device that includes the source 102 can communicate with the communication device 104 through at least one of an uplink and/or a downlink DL.

The communication device 104 can receive the electromagnetic radiation generated by the source 102 and re-transmit the electromagnetic radiation. For example, the communication device 104 can receive first electromagnetic radiation 106 from the source 102 and retransmit second electromagnetic radiation 108. In various examples, information encoded in the first electromagnetic radiation 106 can also be encoded in the second electromagnetic radiation 108. In some scenarios, a signal strength of the second electromagnetic radiation 108 can be less than a signal strength of the first electromagnetic radiation 106. In one or more examples, a difference between a signal strength of the first electromagnetic radiation 106 and the second electromagnetic radiation 108 can be due to loss that takes place by retransmission of the first electromagnetic radiation 106 by the communication device 104. A reduction in signal strength of the second electromagnetic radiation 106 with respect to signal strength of the first electromagnetic radiation 106 can correspond to a reduction in at least one of the electrical field or the magnetic field produced by the second electromagnetic radiation 108 relative to the first electromagnetic radiation 106. In one or more examples, the second electromagnetic radiation 108 can have a lower power density than the first electromagnetic radiation 106. In one or more illustrative examples, the power density of the second electromagnetic radiation 108 can be at least 70% of the power density of the first electromagnetic radiation 106, at least 75% of the power density of the first electromagnetic radiation 106, at least 80% of the power density of the first electromagnetic radiation 106, at least 85% of the power density of the first electromagnetic radiation 106, at least 90% of the power density of the first electromagnetic radiation 106, at least 95% of the power density of the first electromagnetic radiation 106, at least 98% of the power density of the first electromagnetic radiation 106, or at least 99% of the power density of the first electromagnetic radiation 106.

In addition, the first electromagnetic radiation 106 and the second electromagnetic radiation 108 can have frequencies of at least 3 GHz, at least 5 GHz, at least 10 GHz, at least 15 GHz, at least 20 GHz, at least 25 GHz, at least 30 GHz, or at least 35 GHz. Further, the first electromagnetic radiation 106 and the second electromagnetic radiation 108 can have frequencies no greater than 85 GHz, no greater than 75 GHz, no greater than 65 GHz, no greater than 55 GHz, or no greater than 45 GHz. In one or more illustrative examples, the first electromagnetic radiation 106 and the second electromagnetic radiation 108 can have frequencies from 3 GHz to 85 GHz, from 3 GHz to 20 GHz, from 20 GHz to 40 GHz, from 40 GHz to 85 GHz, from 20 GHz to 55 GHz, or from 15 GHz to 35 GHz. In various examples, the first electromagnetic radiation 106 and the second electromagnetic radiation 108 can have frequencies that correspond to the 5G communications standard.

In one or more additional examples, the first electromagnetic radiation 106 and the second electromagnetic radiation 108 can have frequencies of at least 90 GHz, at least 150 GHz, at least 200 GHz, at least 250 GHz, at least 300 GHz, at least 350 GHz, at least 400 GHz, at least 450 GHz, at least 500 GHz, at least 550 GHz, at least 600 GHz, at least 650 GHz, or at least 700 GHz. Further, the first electromagnetic radiation 106 and the second electromagnetic radiation 108 can have frequencies no greater than 3500 GHz, no greater than 3000 GHz, no greater than 2500 GHz, no greater than 2000 GHz, no greater than 1500 GHz, no greater than 1200 GHz, no greater than 1000 GHz, no greater than 950 GHz, no greater than 900 GHz, no greater than 850 GHz, no greater than 800 GHz, no greater than 750 GHz, or no greater than 700 GHz. In one or more illustrative examples, the first electromagnetic radiation 106 and the second electromagnetic radiation 108 can have frequencies from 90 GHz to 3500 GHz, from 90 GHz to 150 GHz, from 100 GHz to 200 GHz, from 150 GHz to 250 GHz, from 150 GHz to 300 GHz, from 200 GHz to 350 GHz, from 300 GHz to 500 GHz, from 500 GHz to 750 GHz, from 750 GHz to 1200 GHz, or from 1000 GHz to 3000 GHz. In various examples, the first electromagnetic radiation 106 and the second electromagnetic radiation 108 can have frequencies that correspond to the sixth generation (6G) communications standard.

The first electromagnetic radiation 106 and the second electromagnetic radiation 108 can have wavelengths in air that correspond to the frequencies of at least one of the 5G communications standard or the 6G communications standard. For example, the first electromagnetic radiation 106 and the second electromagnetic radiation 108 can have wavelengths from 3 mm to 100 mm, from 5 mm to 60 mm, from 5 mm to 15 mm, from 3 mm to 8 mm, or from 7 mm to 15 mm. In one or more additional examples, the first electromagnetic radiation 106 and the second electromagnetic radiation 108 can have wavelengths from 0.1 mm to 3 mm, from 0.3 mm to 1 mm, from 1 mm to 2 mm, from 0.8 mm to 1.5 mm, from 0.6 mm to 1.2 mm, from 0.4 mm to 0.8 mm, from 0.3 mm to 0.5 mm, or from 0.1 mm to 0.4 mm.

The communication device 104 can include an antenna that redirects a path of the first electromagnetic radiation 106 to produce the second electromagnetic radiation 108. In one or more examples, the communication device 104 can include one or more antennas with individual antennas of the one or more antennas having one or more substrates, such as the illustrative substrate 110. In various examples, the first electromagnetic radiation 106 can be incident upon the one or more substrates of an antenna at a first angle and be re-transmitted as the second electromagnetic radiation 108 at a second angle that is different from the first angle. For example, the communication device 104 can include an antenna that causes a phase shift in the first electromagnetic radiation 106 to produce the second electromagnetic radiation. In one or more illustrative examples, the second electromagnetic radiation 108 can be phase shifted with respect to the first electromagnetic radiation 106 by at least 3 degrees, at least 5 degrees, at least 8 degrees, at least 10 degrees, at least 12 degrees, at least 15 degrees, at least 18 degrees, at least 20 degrees, at least 22 degrees, at least 25 degrees, at least 28 degrees, at least 30 degrees, at least 35 degrees, at least 40 degrees, or at least 50 degrees. In one or more additional illustrative examples, the second electromagnetic radiation 108 can be phase shifted with respect to the first electromagnetic radiation 106 by 5 degrees to 50 degrees, by 5 degrees to 15 degrees, by 10 degrees to 20 degrees, by 15 degrees to 25 degrees, by 20 degrees to 30 degrees, by 20 degrees to 40 degrees, by 25 degrees to 35 degrees, or by 30 degrees to 40 degrees.

In the illustrative example of FIG. 1, the first electromagnetic radiation 106 can be incident upon the substrate 110 at a first angle 112 and be re-transmitted as the second electromagnetic radiation at a second angle 114. In one or more examples, a difference between the first angle 112 and the second angle 114 can be from 0.5 degrees to 10 degrees, from 1 degree to 5 degrees, from 2 degrees to 4 degrees, from 3 degrees to 6 degrees, from 3 degrees to 5 degrees, from 2 degrees to 10 degrees, from 4 degrees to 10 degrees, from 6 degrees to 10 degrees, or from 8 degrees to 10 degrees. In situations where the communication device 104 includes an antenna having multiple substrates 110, a total difference between the first angle 112 of the first electromagnetic radiation 106 entering the antenna and the second angle 114 of the second electromagnetic radiation 108 leaving the antenna can be a sum of the individual phase shifts caused by the individual substrates of multiple substrates included in the antenna.

The substrate 110 can include a first surface 116 and a second surface 118. A number of features can be disposed on at least one of the first surface 116 or the second surface 118 to cause the second electromagnetic radiation 108 to be re-transmitted at the second angle 114 from the first angle 112 of the first electromagnetic radiation 106. In one or more examples, features can be formed on at least one of the first surface 116 or the second surface 118 from conductive materials to cause the second electromagnetic radiation 108 to be re-transmitted at the second angle 114 from the first angle 112 of the first electromagnetic radiation 106. For example, a group of features 120 can be disposed on the first surface 116. The group of features 120 can include a number of unit cells, such as a first unit cell 122 and a second unit cell 124. A pattern of conductive materials can be disposed within individual unit cells. To illustrate, the first unit cell 122 can include a first pattern 126 formed from one or more conductive materials and the second unit cell 124 can include a second pattern 128 formed from one or more conductive materials. In the illustrative example of FIG. 1, the first pattern 126 can correspond to a Minkowski fractal pattern and the second pattern 128 can correspond to a pattern of crosses. In one or more additional examples, at least one of the first pattern 126 or the second pattern 128 can correspond to a Hilbert pattern or a Koch snowflake pattern. In various examples, the patterns included in the unit cells can cause the second electromagnetic radiation 108 to be re-transmitted at the second angle 114 from the first angle 112 of the first electromagnetic radiation 106.

Additionally, although the illustrative example of FIG. 1 shows that the first pattern 126 is different from the second pattern 128, in one or more additional examples, the first pattern 126 and the second pattern 128 can be the same. For example, the first unit cell 122 can include a pattern of conductive material that corresponds to a pattern of conductive material of the second unit cell 124. In various examples, a plurality of unit cells of the group of features 120 can include a same pattern of conductive material. In one or more examples, at least 50%, at least 60%, at least 70%, at least 80%, at least 90%, or at least 95% of the unit cells of the group of features 120 can include a same pattern of conductive material. In one or more examples, the group of features can include additional features. To illustrate, the group of features 120 can include a number of additional active components, such as one or more varactors, one or more pin diodes, one or more transistors, one or more micro electro-mechanical systems (MEMS), one or more ferroelectric films, one or more graphene-based features, one or more combinations thereof, and the like. In at least some examples, at least a portion of the additional active components can be located in unit cells. Further, the group of features 120 can include connectors formed from conductive materials that couple the active components and/or features disposed in the unit cells such that current can be applied to at least a portion of the group of features 120. In one or more illustrative examples, a voltage can be applied to an antenna included in the communication device 104 that includes the substrate 110 in order to cause the first electromagnetic radiation 106 to be re-transmitted or reflected by features disposed on at least one of the first surface 116 or the second surface 118.

In one or more examples, an additional group of features can be disposed on the second surface 118. In various examples, an additional group of features disposed on the second surface 118 can be the same as or similar to the group of features 120 disposed on the first surface 116. In one or more additional examples, an additional group of features disposed on the second surface 118 can be different from the group of features 120 disposed on the first surface 120. In at least some examples, features disposed on the first surface 116 can be coupled with features disposed on the second surface 118. For example, one or more connectors can couple features disposed on the first surface 116 with features disposed on the second surface 118. To illustrate, one or more vias can be formed in the substrate 110 that can be at least partially filled with conductive material to couple features disposed on the first surface 116 with features disposed on the second surface 118. In one or more illustrative examples, the group of features 120 disposed on the first surface 116 and/or an additional group of features disposed on the second surface 118 can comprise a frequency selective surface (FSS). In one or more additional illustrative examples, the group of features 120 disposed on the first surface 116 and/or an additional group of features disposed on the second surface 118 can comprise a metasurface.

In one or more illustrative examples, the group of features 120 disposed on the first surface 116 and/or additional features disposed on the second surface 118 can include components based on the frequencies of the first electromagnetic radiation 106. In addition, the group of features 120 disposed on the first surface 116 and/or additional features disposed on the second surface 118 can include components based on an amount of difference between the first angle 112 and the second angle 114. In various examples, as the frequencies of the first electromagnetic radiation 106 and/or the difference between the first angle 112 and the second angle 114 change, features disposed on at least one of the first surface 116 or the second surface 118 can be different. Further, although the illustrative example of FIG. 1 indicates that the communication device 104 can include a transmitarray, in one or more additional examples, the communication device 104 can include a reflectarray or a reconfigurable intelligent surface. In scenarios where the communication device 104 includes a reflectarray or a reconfigurable intelligent surface, the features disposed on the first surface 116 and/or the second surface 118 can provide functionality that corresponds to reflectarrays or reconfigurable intelligent surfaces. In implementations where the communication device 104 includes a reflectarray, the features disposed on the first surface 116 and the second surface 118 can cause at least 80%, at least 85%, at least 90%, at least 95%, or at least 99% of the first electromagnetic radiation 106 to be reflected at the first surface 116.

The substrate 110 can comprise one or more materials. In one or more examples, the substrate 110 can comprise one or more glass materials. In one or more examples, the substrate 110 can comprise at least 60% by weight of one or more glass materials, at least 65% by weight of one or more glass materials, at least 70% by weight of one or more glass materials, at least 75% by weight of one or more glass materials, at least 80% by weight of one or more glass materials, at least 85% by weight of one or more glass materials, at least 90% by weight of one or more glass materials, at least 95% by weight of one or more glass materials, or at least 99% by weight of one or more glass materials In various examples, the substrate 110 can comprise a glass material having an amount of silica and an amount of one or more additional components. As used herein, the term “silica” can refer to silicon dioxide (SiO₂). In one or more illustrative examples, the substrate 110 can comprise pure silica. In one or more additional illustrative examples, the substrate 110 can comprise fused silica. In one or more further illustrative examples, the substrate 110 can comprise one or more aluminum oxides. For example, the substrate 110 can comprise Al₂O₃. In still further illustrative examples, the substrate 110 can comprise boron trioxide (B₂O₃). In various illustrative examples, the substrate 110 can comprise one or more alkaline earth metals. To illustrate, the substrate 110 can comprise at least one of MgO, CaO, SrO, or BaO. In one or more implementations, the substrate 110 can comprise an alkaline earth boroaluminosilicate glass.

In one or more implementations, the substrate 110 can comprise a glass material having silica content that is greater than content of any other component of the glass material. For example, the substrate 110 can comprise at least 50 mole % silica, at least 55 mole % silica, at least 60 mole % silica, at least 65 mole % silica, at least 70 mole % silica, at least 75 mole % silica, at least 80 mole % silica, at least 85 mole % silica by weight, at least 90 mole % silica, at least about 95 mole % silica, or at least about 99 mole % silica. In various examples, substantially all of the substrate 110 can be comprised of silica. In one or more illustrative examples, the substrate 110 can be comprised of pure silica. In one or more additional illustrative examples, the substrate 110 can be comprised of from about 50 mole % silica to about 99 mole % silica, from about 60 mole % to about 90 mole % silica, from about 75 mole % to about 95 mole % silica, from about 50 mole % silica to about 70 mole % silica, from about 60 mole % silica to about 80 mole % silica, or from about 80 mole % silica to about 95 mole % silica.

In scenarios where the substrate 110 comprises an aluminum oxide, the amount of aluminum oxide present in the substrate 110 can be from 5 mole % to 40 mole %, from 10 mole % to 30 mole %, from 20 mole % to 40 mole %, from 10 mole % to 20 mole %, from 20 mole % to 30 mole %, or from 25 mole % to 40 mole %. In implementations where the substrate 110 comprises boron trioxide, the amount of boron trioxide present in the substrate 110 can be from 5 mole % to 40 mole %, from 10 mole % to 30 mole %, from 20 mole % to 40 mole %, from 10 mole % to 20 mole %, from 20 mole % to 30 mole %, or from 25 mole % to 40 mole %. Additionally, in instances where the substrate 110 comprises one or more alkaline earth metals, the amount of an individual alkaline earth metal present in the substrate 110 can comprise from 0.05 mole % to 10 mole %, from 0.5 mole % to 10 mole %, from 2 mole % to 10 mole %, from 2 mole % to 5 mole %, from 6 mole % to 9 mole %, or from 0.05 mole % to 1 mole %. Mole % as used herein can refer to mole percent calculated on an oxide basis.

Further, the substrate 110 can have a relative permittivity at standard temperature and pressure of no greater than 6.0 farads/meter (F/m), no greater than 5.5 F/m, no greater than 5.0 F/m, no greater than 4.8 F/m, no greater than 4.5 F/m, no greater than 4.2 F/m, no greater than 4.0 F/m, no greater than 3.5 F/m, no greater than 3.0 F/m, no greater than 2.5 F/m, no greater than 2.0 F/m, or no greater than 1.5 F/m. In one or more illustrative examples, the substrate 110 can have a relative permittivity from 1.5 F/m to 6.0 F/m, from 3.5 F/m to 5.5 F/m, from 4.0 F/m to 6.0 F/m, from 5.0 F/m to 6.0 F/m, from 4.5 F/m to 5.5 F/m, or from 3.0 F/m to 4.0 F/m. The relative permittivity can also be referred to herein as dielectric constant. The relative permittivity can be calculated as a ratio of the complex frequency dependent permittivity of a material in the relation to the vacuum permittivity.

In one or more examples, the substrate 110 can have a mechanical strength to minimize curvature of the substrate 110. As a result, a direction of the re-transmitted second electromagnetic radiation 108 can be more accurately determined than in situations where the substrate 110 has an amount of curvature. In various examples, the mechanical strength of the substrate 110 can be achieved without the use of support structures and/or the use of support fibers within the substrate 110. Thus, the mechanical strength of the substrate 110 can be achieved based on properties of the glass that comprises the substate 110. In one or more illustrative examples, the substrate can have a Young's modulus of at least 30 gigapascals (GPa), at least 35 GPa, at least 40 GPa, at least 45 GPa, at least 50 GPa, at least 55 GPa, at least 60 GPa, at least 60 GPa, at least 65 GPa, at least 70 GPa, at least 75 GPa, at least 80 GPa, at least 85 GPa, or at least 90 GPa. In one or more additional illustrative examples, the substrate 110 can have a Young's modulus from 30 GPa to 150 GPa, from 30 GPa to 100 GPa, from 30 GPa to 50 GPa, from 30 GPa to 40 GPa, from 40 GPa to 80 GPa, from 50 GPa to 90 GPa, from 60 GPa to 80 GPa, or from 90 GPa to 150 GPa.

In various examples, the substrate 110 can be optically transparent. To illustrate, the substrate 110 can have an optical transparency of at least 70%, at least 75%, at least 80%, at least 85%, at least 90%, at least 95%, at least 99%, at least 99.5%, or at least 99.9%. In one or more illustrative examples, the substrate 110 can have an optical transparency from 70% to 100%, from 80% to 99.5%, from 90% to 99%, or from 95% to 99.5%.

The group of features 120 disposed on the first surface 116 and/or additional features disposed on the second surface 118 can be formed from materials that include one or more metals. In one or more examples, features included in unit cells of at least one of the first surface 116 or the second surface 118 can be formed from one or more metallic materials. In various examples, at least one of the first pattern 126 or the second pattern 128 can be formed from one or more metallic materials. In one or more examples, metallic features formed on the first surface 116 and/or the second surface 118 can be formed materials that include at least one of copper, an alloy of copper, titanium, or an alloy of titanium. In one or more illustrative examples, the metallic features disposed on at least one of the first surface 116 or the second surface 118 can comprise at least 80% copper by weight, at least 82% copper by weight, at least 85% copper by weight, at least 88% copper by weight, at least 90% copper by weight, at least 92% copper by weight, at least 95% copper by weight, at least 98% copper by weight, at least 99% copper by weight, or at least 99.5% copper by weight. In one or more additional illustrative examples, metallic features disposed on at least one of the first surface 116 or the second surface 118 can be comprised of substantially all copper.

In various examples, metallic features disposed on at least one of the first surface 116 or the second surface 118 can have an electrical conductivity at 20° C. of at least 40 MegaSiemens per meter (MS/m), at least 45 MS/m, at least 50 MS/m, at least 55 MS/m, at least 60 MS/m, at least 65 MS/m, or at least 70 MS/m. In one or more illustrative examples, conductive features disposed on the first surface 116 or the second surface 118 can be formed from one or more metallic materials having an electrical conductivity at 20° C. from 40 MS/m to 70 MS/m, from 45 MS/m to 65 MS/m, from 50 MS/m to 60 MS/m, or from 55 MS/m to 60 MS/m.

FIG. 2 illustrates an example partial cross-section view of a substrate 110 that includes a number of features to direct the path of electromagnetic radiation, according to one or more implementations. For example, the substrate 110 can include a first feature 202 disposed on a first surface 204 and a second features 206 disposed on a second surface 208. The first feature 202 can be electrically and/or physically coupled to the second feature 206 by a via 210 that is disposed in the substrate 110. The first feature 202, the second feature 206, and the via 210 can comprise one or more metallic materials. For example, at least one of the first feature 202, the second feature 206, or the via 210 can comprise copper, one or more alloys of copper, aluminum, one or more alloys of aluminum, titanium, one or more alloys of titanium, or one or more combinations thereof. The first feature 202 and/or the second feature 206 can include a pattern formed from one or more metallic materials. The pattern can include a Minkowski fractal pattern, a Hilbert pattern, a Koch snowflake pattern, or cross fractal pattern. In various examples, the first feature 202 and/or the second features 206 can be included in or comprise a respective unit cell of a plurality of unit cells formed on at least one of the first surface 204 or the second surface 208. In one or more illustrative examples, the plurality of unit cells can be arranged according to a pattern. To illustrate, the plurality of unit cells can be arranged according to a grid.

In one or more examples, the first feature 202 and the second feature 206 can have a width 212 and a height 214. The width 212 can correspond to a wavelength of electromagnetic radiation incident on at least one of the first surface 204 or the second surface 208. For example, the width 212 can be 0.05 times the wavelength of electromagnetic radiation incident on at least one of the first surface 204 or the second surface 208, 0.1 times the wavelength of electromagnetic radiation incident on at least one of the first surface 204 or the second surface 208, 0.15 times the wavelength of electromagnetic radiation incident on at least one of the first surface 204 or the second surface 208, 0.2 times the wavelength of electromagnetic radiation incident on at least one of the first surface 204 or the second surface 208, 0.25 times the wavelength of electromagnetic radiation incident on at least one of the first surface 204 or the second surface 208, 0.3 times the wavelength of electromagnetic radiation incident on at least one of the first surface 204 or the second surface 208, 0.35 times the wavelength of electromagnetic radiation incident on at least one of the first surface 204 or the second surface 208, or 0.4 times the wavelength of electromagnetic radiation incident on at least one of the first surface 204 or the second surface 208. In one or more illustrative examples, the width 212 can be from 0.05 times the wavelength of electromagnetic radiation incident on at least one of the first surface 204 or the second surface 208 to 0.40 times the wavelength of electromagnetic radiation incident on at least one of the first surface 204 or the second surface 208, from 0.05 times the wavelength of electromagnetic radiation incident on at least one of the first surface 204 or the second surface 208 to 0.25 times the wavelength of electromagnetic radiation incident on at least one of the first surface 204 or the second surface 208, from 0.1 times the wavelength of electromagnetic radiation incident on at least one of the first surface 204 or the second surface 208 to 0.2 times the wavelength of electromagnetic radiation incident on at least one of the first surface 204 or the second surface 208, or from 0.2 times the wavelength of electromagnetic radiation incident on at least one of the first surface 204 or the second surface 208 to 0.3 times the wavelength of electromagnetic radiation incident on at least one of the first surface 204 or the second surface 208. In one or more additional examples, the width 212 can be from 0.01 mm to 1 mm, from 0.05 mm to 0.5 mm, from 0.1 mm to 0.5 mm, from 0.3 mm to 0.7 mm, from 0.5 mm to 1 mm, from 0.4 mm to 0.6 mm, or from 0.4 mm to 0.8 mm.

Additionally, the height 214 of at least one of the first feature 202 or the second feature 206 can be no greater than 1.1 micrometers, no greater than 0.9 micrometers, no greater than 0.7 micrometers, no greater than 0.5 micrometers, no greater than 0.3 micrometers, or no greater than 0.1 micrometers. In one or more illustrative examples, the height 214 can be from 0.05 micrometers to 1.1 micrometers, from 0.1 micrometers to 0.5 micrometers, from 0.2 micrometers to 0.4 micrometers, from 0.3 micrometers to 0.6 micrometers, from 0.4 micrometers to 0.8 micrometers, or from 0.5 micrometers to 1.0 micrometers.

The width of the via 210 can be greater than the height 214. In one or more examples, the width of the via 210 being greater than the height 214 of the features formed on the first surface 204 and the features formed on the second surface 208 can decrease signal loss. In one or more illustrative examples, the width of the via 210 can be from 0.1 micrometers to 1.3 micrometers, from 0.3 micrometers to 0.7 micrometers, from 0.5 micrometers to 1.0 micrometers, from 0.4 micrometers to 0.8 micrometers, from 0.7 micrometers to 1.0 micrometers, or from 0.8 micrometers to 1.2 micrometers.

In various examples, a surface roughness of the substrate 110 can be less than the thickness 214. For example, the surface roughness of the substrate 110 can be no greater than 0.6 micrometers, no greater than 0.5 micrometers, no greater than 0.4 micrometers, no greater than 0.3 micrometers, no greater than 0.2 micrometers, no greater than 0.1 micrometers, no greater than 0.05 micrometers, or no greater than 0.01 micrometers. In one or more additional illustrative examples, the surface roughness of the substrate 110 can be from 0.01 micrometers to 0.6 micrometers, from 0.1 micrometers to 0.5 micrometers, from 0.2 micrometers to 0.4 micrometers, or from 0.3 micrometers to 0.5 micrometers. The surface roughness of the substrate 110 can correspond to an average surface roughness of at least a sample portion of the substrate 110. The average surface roughness can correspond to an arithmetic average of profile height deviations from the mean line. The surface roughness can also correspond to a root mean square average of profile height deviations from the mean line. In addition, the surface roughness can correspond to at least one of maximum valley depth below the mean line within a single sampling length, maximum peak height above the mean line within a single sampling length, or maximum peak to valley height of the profile within a single sampling length. In one or more further examples, the surface roughness can correspond to measure of peakedness of the profile above the mean line. In still additional examples, surface roughness can correspond to average distance between the highest peak and lowest valley in each sampling length. In still further examples, the surface roughness can correspond to the five highest peaks and lowest valleys over the entire sampling length.

In one or more examples, based on the surface roughness of the substrate 110 being less than the height 214, signal loss can be reduced with respect to electromagnetic radiation having frequencies of at least 3 GHz. The surface roughness can be measured with a contact-type roughness meter. In one or more examples, the surface roughness can be measured by tracing a probe across the surface of a target. In one or more additional examples, surface roughness can be measured by a laser-based non-contact roughness meter that emits a laser beam onto the target and detects the reflected light to measure the roughness.

Further, minimizing surface roughness of the substrate 110 can reduce phase error with respect to the amount of phase shift produced electromagnetic radiation incident on at least one of the first surface 204 or the second surface 208. Phase error can be determined according to (360/(effective wavelength))×(pattern accuracy)×(total pattern length of unit cell), where effective wavelength is given in meters, pattern accuracy is expressed as a percentage, and total pattern length of unit cell is given in meters. The total pattern length of a unit cell can correspond to length of electrical current path realized on metallic material that comprises the pattern of the unit cell, such as amount of length of metallic material used to form a Hilbert curve in a unit cell or an amount of length of metallic material used to form a Minkowski fractal pattern. In one or more examples, pattern length variation can be a measure of pattern accuracy and can be no greater than 0.05 mm, no greater than 0.04 mm, no greater than 0.03 mm, no greater than 0.02 mm, no greater than 0.01 mm, no greater than 0.008 mm, no greater than 0.006 mm, or no greater than 0.004 mm. In one or more illustrative examples, the phase error can be no greater than 8 degrees, no greater than 7 degrees, no greater than 6 degrees, no greater than 5 degrees, no greater than 4 degrees, no greater than 3 degrees, no greater than 2 degrees, no greater than 1 degree, or no greater than 0.5 degrees. By minimizing phase error, the accuracy of the path of electromagnetic radiation directed using the substrate 110 can be increased.

The substrate 110 can have a height 216, a width 218, and a length 220. In one or more examples, the dimensions of the substrate 110 can be based on a device in which the substrate 110 is included. In one or more examples, the substrate 110 can be included in an antenna. For example, the substrate 110 can be included in an antenna that is included in a base station of a communications system. In one or more illustrative examples, the height 214 can be no greater than 0.8 mm, no greater than 0.7 mm, no greater than 0.6 mm, no greater than 0.5 mm, no greater than 0.4 mm, no greater than 0.3 mm, no greater than 0.2 mm, or no greater than 0.1 mm. In one or more additional illustrative examples, the height 216 can be from 0.05 mm to 1 mm, from 0.1 mm to 0.8 mm, from 0.2 mm to 0.5 mm, from 0.3 mm to 0.6 mm, from 0.4 mm to 0.7 mm, from 0.4 mm to 0.6 mm, from 0.5 mm to 0.7 mm, from 0.6 mm to 0.8 mm, or from 0.7 mm to 1 mm. In one or more further illustrative examples, the width 218 can be from 2 cm to 100 cm, from 5 cm to 80 cm, from 10 cm to 60 cm, from 20 cm to 50 cm, from 30 cm to 60 cm, from 40 cm to 80 cm, from 50 cm to 90 cm, from 10 cm to 40 cm. In various examples, the length 220 can be from 2 cm to 200 cm, from 5 cm to 80 cm, from 10 cm, from 50 cm to 150 cm, from 100 cm to 200 cm, or from 120 cm to 180 cm.to 60 cm, from 20 cm to 50 cm, from 30 cm to 60 cm, from 40 cm to 80 cm, from 50 cm to 90 cm, from 10 cm to 40 cm, from 50 cm to 150 cm, from 100 cm to 200 cm, or from 120 cm to 180 cm. In one or more examples, the substrate 110 can have a height 216 from 0.4 mm to 0.7 mm, a width 218 from 10 cm to 60 cm, and a length 220 from 10 cm to 60 cm.

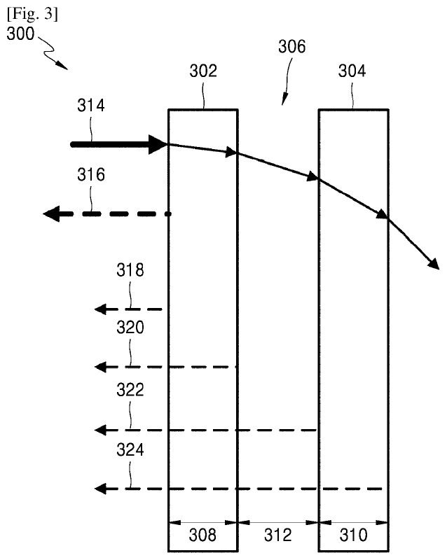

FIG. 3 illustrates an example device 300 that includes multiple substrates to direct the path of electromagnetic radiation, according to one or more implementations. The device 300 can include a plurality of substrates. For example, the device 300 can include at least a first substrate 302 and a second substrate 304. The first substrate 302 and the second substrate 304 can individually have a composition, features, and characteristics of the substrate 110 described with respect to FIG. 1 and FIG. 2. A gap 306 can be disposed between the first substrate 302 and the second substrate 304. The gap 306 can be filled with one or more substances. For example, the gap 306 can be filled with one or more gases. In one or more illustrative examples, the gap 306 can be filled with air. In one or more additional illustrative examples, the gap 306 can comprise a vacuum.

The first substrate 302 can have a first thickness 308 and the second substrate 304 can have a second thickness 310. Values of the first thickness 308 and the second thickness 310 can correspond to the height 216 of the substrate 110. Additionally, the gap 306 can have a thickness 312. The thickness 312 can be based on a wavelength of electromagnetic radiation that is being directed by the device 300. For example, the thickness 312 can be 0.60 times the wavelength of electromagnetic radiation being directed by the device 300, 0.55 times the wavelength of electromagnetic radiation being directed by the device 300, 0.50 times the wavelength of electromagnetic radiation being directed by the device 300, 0.45 times the wavelength of electromagnetic radiation being directed by the device 300, 0.40 times the wavelength of electromagnetic radiation being directed by the device 300, 0.35 times the wavelength of electromagnetic radiation being directed by the device 300, 0.30 times the wavelength of electromagnetic radiation being directed by the device 300, 0.25 times the wavelength of electromagnetic radiation being directed by the device 300, 0.20 times the wavelength of electromagnetic radiation being directed by the device 300, 0.15 times the wavelength of electromagnetic radiation being directed by the device 300, or 0.10 times the wavelength of electromagnetic radiation being directed by the device 300. In one or more illustrative examples, the thickness 312 can be from 0.1 times to 0.5 times the wavelength of electromagnetic radiation being directed by the device 300, from 0.2 times to 0.3 times the wavelength of electromagnetic radiation being directed by the device 300, or 0.4 times to 0.5 times the wavelength of electromagnetic radiation being directed by the device 300. In one or more illustrative examples, the thickness 312 can be from 0.1 mm to 10 mm, from 0.5 mm to 5 mm, from 1 mm to 4 mm, from 0.1 mm to 2 mm, from 0.1 mm to 1 mm, from 0.5 mm to 3 mm, from 2 mm to 5 mm, from 1 mm to 3 mm, from 5 mm to 7 mm, from 6 mm to 8 mm, or from 7 mm to 9 mm.

In various examples, the characteristics of the substrates 302, 304, the thicknesses 308, 310, and the thickness 312 of the gap 306 can be configured to achieve a specified amount of reflection of incident electromagnetic radiation 314. In one or more examples, the incident electromagnetic radiation 314 can correspond to the first electromagnetic radiation 106 of FIG. 1. For example, the relative permittivity of the substrates 302, 304, the thicknesses 308, 310, and the thickness 312 can be configured to produce a total amount of reflectance 316 of the incident electromagnetic radiation 314. To illustrate, the total amount of reflectance 316 can be comprised of a number of components. The individual components comprising the total amount of reflectance 316 can be determined based on the relative permittivities of the substrates 302, 304 and the relative permittivity of one or more substances disposed within the gap 306. The individual components of the total amount of reflectance 316 can also be based on the thicknesses 308, 310 of the substrates 302, 304, respectively, and the thickness 312 of the gap 306. In one or more illustrative examples, the relative permittivity of the first substrate 302, the relative permittivity of the second substrate 304, the relative permittivity of the gap 306, the thickness 308 of the first substrate 302, the thickness 310 of the second substrate 310, and the thickness 312 of the gap 306 can be determined to produce a total amount of reflectance 316 that corresponds to a total reflection coefficient no greater than 0.70, no greater than 0.68, no greater than 0.65, no greater than 0.62, no greater than 0.60, no greater than 0.58, no greater than 0.55, no greater than 0.52, no greater than 0.50, no greater than 0.48, no greater than 0.45, no greater than 0.42, or no greater than 0.40. In one or more illustrative examples, a magnitude of the total reflection coefficient can be from 0.30 to 0.70, from 0.40 to 0.60, from 0.50 to 0.70, from 0.50 to 0.60, or from 0.55 to 0.65. In one or more additional examples, the individual components of the amount of total reflectance can correspond to a first amount of reflectance 316 with respect to an interface of a first surface of the first substrate 302 with a medium through which the electromagnetic radiation 314 is traveling, a second amount of reflectance 318 with respect to an interface of a second surface of the first substrate 302 disposed opposite the first surface of the first substrate 302 and a medium comprising the gap 306, a third amount of reflectance 322 with respect to an interface of the medium comprising the gap 306 and a first surface of the second substrate 304, and a fourth amount of reflectance 324 with respect to an interface of a second surface of the second substrate 304 disposed parallel to the first surface of the second substrate 304 and a medium contacting the second surface of the second substrate 304.

In one or more non-limiting illustrative examples, a magnitude of the total reflection coefficient can be determined using the following equations:

$${Γ}_{in =} {Γ}_{0} + {Γ}_{1} {e}^{- j 2 {β}_{1} {d}_{1}} + {Γ}_{2} {e}^{- j 2 ( {β}_{1} {d}_{1} + {β}_{2} {d}_{2} )} + {Γ}_{3} {e}^{- j 2 ( {β}_{1} {d}_{1} + {β}_{2} {d}_{3} + {β}_{3} {d}_{3} )} \qquad ( 1 )$$

$$\begin{matrix}{Γ}_{0} = \frac{{η}_{1} - {η}_{0}}{{η}_{1} + {η}_{0}} & {Γ}_{1} = \frac{{η}_{2} - {η}_{1}}{{η}_{2} + {η}_{1}} & {Γ}_{2} = \frac{{η}_{3} - {η}_{2}}{{η}_{3} + {η}_{2}} & {Γ}_{3} = \frac{{η}_{4} - {η}_{3}}{{η}_{4} + {η}_{3}}\end{matrix} \qquad ( 2 )$$

$${η}_{n} = \sqrt{\frac{{μ}_{n} \times {μ}_{0}}{{ε}_{n} \times {ε}_{0}}} where {ε}_{0} = 8.854 \times {10}^{- 12} F \cdot {m}^{- 1} and {μ}_{0} = 4 π \times {10}^{- 7} H \cdot {m}^{- 1} \qquad ( 3 )$$

$${β}_{n} = \frac{2 π}{{λ}_{n}} where {β}_{n} = \frac{2 π}{{λ}_{n}} . \qquad ( 4 )$$

In equations 1-4, Γᵢₙ in corresponds to a total amount of reflection, Γ₀ corresponds to an amount of reflection at the interface of a first surface of the first substrate 302 with a medium through which the incident electromagnetic radiation 314 is traveling, Γ₁e^{--j}2^{β}₁^{d}₁ corresponds to an amount of reflection at the interface of a second surface of the first substrate 302 disposed opposite the first surface of the first substrate 302 and a medium comprising the gap 306, Γ₃e^{--j}2^{(β}₁^{d}₁^{+β}₂^{d}₂) corresponds to an amount of reflection at the interface of the medium comprising the gap 306 and a first surface of the second substrate 304, and Γ₄e^{--j}2^{(β}₁^{d}₁^{+β}₂^{d}₂⁾ corresponds to an amount of reflection at the interface of a second surface of the second substrate 304 disposed parallel to the first surface of the second substrate 304 and a medium contacting the second surface of the second substrate 304. In addition, ε corresponds to relative permittivity of a material and u corresponds to permeability of a material, such that ε₀ and μ₀ correspond to the medium before the first substrate 302, ε₁ and μ₁ correspond to the material of the first substrate 302, ε₂ and μ₂ correspond to a medium within the gap 306, ε₃ and μ₃ correspond to the second substrate 304, and ε₄ and μ₄ correspond to a medium disposed after the second substrate 304. Further, η corresponds to a measure of permeability/permittivity for a given substance, such that η₀ corresponds to the medium before the first substrate 302, η₁ corresponds to the material of the first substrate 302, η₂ corresponds to a medium within the gap 306, η₃ corresponds to the second substrate 304, and η₄ corresponds to a medium disposed after the second substrate 304. Also, λ corresponds to the wavelength within a given substance, such that λ₀ corresponds to the wavelength in the medium before the first substrate 302, λ₁ corresponds to the wavelength in the first substrate 302, λ₂ corresponds to the wavelength in a medium within the gap 306, λ₃ corresponds to the wavelength in the second substrate 304, and λ₄ corresponds to the wavelength in a medium disposed after the second substrate 304.

Although the total amount of reflectance 316 in the illustrative example of FIG. 3 includes the first component 318, the second component 320, the third component 322, and the fourth component 324, in other implementations, the total amount of reflectance 316 can include more components or fewer components. For example, in scenarios where the device 300 includes a single substrate, the total amount of reflectance can include fewer components. Additionally, in this situation, the total reflection coefficient can be less than the total reflection coefficient produced when the device 300 includes two substrates. In addition, in instances where the device 300 includes more substrates and respective gaps between the substrates, the total amount of reflectance can include more components than components 318, 320, 322, 324 of FIG. 3. To illustrate, in implementations where the device 300 includes three substrates and has two gaps, the total amount of reflectance can include six components and in implementations where the device includes four substrates and three gaps, the total amount of reflectance can include eight components. In these scenarios, the total reflection coefficient can be greater than the total reflection coefficient where the device 300 includes two substrates. In various examples, regardless of the number of substrates and gaps included in the device 300, the relative permittivities of the substrates, the relative permittivities of substances in the gap(s), the thickness of the substrates, and the thickness of the gap(s) can be determined to minimize the total reflection coefficient.

Further, a path of the incident electromagnetic radiation 314 can be modified at the individual interfaces between different media of the device 300. For example, the path of the incident electromagnetic radiation 314 can be modified by a first amount at the interface of a first surface of the first substrate 302 with a medium through which the incident electromagnetic radiation 314 is traveling. In addition, the path of the incident electromagnetic radiation 314 can be modified by a second amount at the interface of a second surface of the first substrate 302 disposed opposite the first surface of the first substrate 302 and a medium comprising the gap 306. Further, the path of the incident electromagnetic radiation 314 can be modified by a third amount at the interface of the medium comprising the gap 306 and a first surface of the second substrate 304. The path of the incident electromagnetic radiation 314 can also be modified by a fourth amount at the interface of a second surface of the second substrate 304 disposed parallel to the first surface of the second substrate 304 and a medium contacting the second surface of the second substrate 304. In one or more examples, a modification to the path of the incident electromagnetic radiation 314 at a respective interface of the device 300 can correspond to a phase shift that changes the angle at which the electromagnetic radiation 314 is traveling with respect to the respective interface. In various examples where the device 300 includes additional substrates, the path of the incident electromagnetic radiation can be further modified according to the number of additional substrates included in the device 300.

Additionally, the amount of modification of the path of the electromagnetic radiation 314 at the individual interfaces can be based on relative permittivities of the substrates 302, 304, relative permittivity of one or more substances within the gap 306, the thicknesses 308, 310, 312, and characteristics of features formed on surface of the substrates 302, 304. In one or more illustrative examples, for individual substrates included in the device 300, a phase shift from 1 degree to 6 degrees can be produced, a phase shift from 2 degrees to 5 degrees can be produced, a phase shift from 3 degrees to 6 degrees can be produced, or a phase shift from 4 degrees to 6 degrees can be produced. In scenarios where the device 300 includes two substrates, a total phase shift from 2 degrees to 12 degrees can be produced, a total phase shift from 4 degrees to 10 degrees can be produced, or a phase shift from 8 degrees to 12 degrees can be produced. Further, in situations where the device 300 include 5 substrates, a total phase shift from 5 degrees to 30 degrees can be produced, a total phase shift from 20 degrees to 30 degrees can be produced, a total phase shift from 15 degrees to 25 degrees can be produced, or a total phase shift from 25 degrees to 30 degrees can be produced.

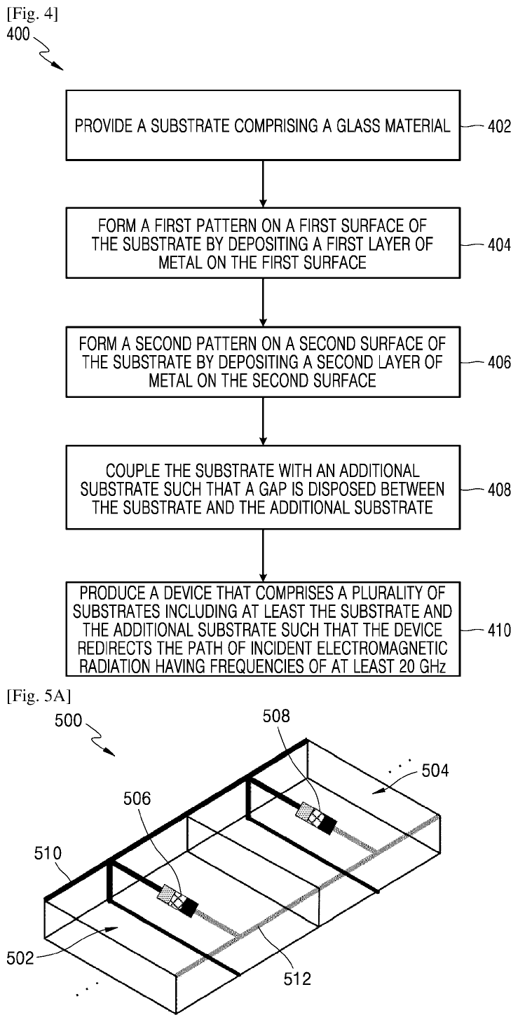

FIG. 4 illustrates a flowchart of an example process 400 to produce a device that directs the path of electromagnetic radiation, in accordance with one or more implementations. The process 400 can include, at 402, providing a substrate comprising a glass material. In one or more examples, the glass material of the substrate can comprise at least 50 mole % silica on an oxide basis. In addition, the substrate can have a relative permittivity no greater than 6.0. Further, the substrate can have a thickness from 0.2 mm to 0.6 mm. In one or more examples, the substrate can have a Young's modulus of at least 30 GPa. In one or more additional examples, the substrate can have a surface roughness of no greater than 0.3 mm. In one or more examples, the substrate can be an optically transmissive substrate having a transparency value of at least 95%.

In addition, the process 400 can include, at 404, forming a first pattern on a first surface of the substrate by depositing a first layer of metal on the first surface. In one or more examples, one or more mask layers can be deposited on the first surface of the substrate based on the first pattern. In one or more additional examples, the first pattern can be formed on the first surface by performing a first sputtering process to deposit the first layer of metal onto the first surface. In one or more further examples, the first pattern can be formed by performing a first electron beam deposition process to deposit the first layer of metal onto the first surface. After depositing the metal on the first surface according to the pattern, the one or more mask layers can be removed.

Further, the process 400 can include, at 406 forming a second pattern on a second surface of the substrate by depositing a second layer of metal on the second surface. In various examples, the second layer of metal can be deposited on the second surface of the substrate. In one or more examples, one or more mask layers can be deposited on the second surface of the substrate based on the second pattern. In one or more additional examples, the second pattern can be formed on the second surface by performing a second sputtering process after the first sputtering process to deposit the second layer of metal onto the second surface. In one or more further examples, the second pattern can be formed by performing a second electron beam deposition process after the first electron beam deposition process to deposit the second layer of metal onto the second surface.

The first pattern can include a number of features. For example, the first pattern can include a number of unit cells. The unit cells can be arranged according to a grid, in various examples. The unit cells can include structures formed according to one or more designs, such as a Minkowski fractal pattern, a Koch snowflake pattern, a Hilbert curve pattern, or a cross fractal pattern. In various examples, the first pattern can comprise a frequency selection surface or a metasurface to direct the path of electromagnetic radiation. Additional features can be formed on the first surface. To illustrate, at least one of varactors, one or more pin diodes, one or more transistors, one or more micro electro-mechanical systems (MEMS), one or more ferroelectric films, one or more graphene-based features, one or more combinations thereof, and the like, can be formed on the first surface. At least a portion of the features of the first pattern can be activated by applying a voltage to cause electromagnetic radiation to be directed along a path. Features that can be activated by the voltage can be referred to herein as “active components.”

In one or more examples, the second pattern can correspond to the first pattern. In one or more illustrative examples, the second pattern can be the same as the first pattern. In various examples, at least a portion of the features of the first pattern can be coupled to at least a portion of the features of the second pattern. In at least some examples, a number of vias can be formed in the substrate and conductive material can be deposited in the vias to couple one or more features of the first pattern with one or more features of the second pattern. The vias can be formed in the substrate using one or more laser projection processes and one or more chemical etching processes. The diameter of the vias can be greater than a height of the features formed on the first surface according to the first pattern and a height of the features formed on the second surface according to the second pattern.

The metal used to form the first pattern and the second pattern can comprise at least one of copper or titanium. In addition, the metal used to form the first pattern and the second pattern can have an electrical conductivity at 20° C. from 40 MegaSiemens per meter (MS/m) to 60 MS/m. Further, a height of the metal deposited on the first surface to produce the first pattern and on the second surface to produce the second pattern can be from 0.1 micrometers to 500 micrometers.

The process 400 can also include, at 408, coupling the substrate with an additional substrate such that a gap is disposed between the substrate and the additional substrate. In one or more examples, a gas can be disposed in the gap. In one or more illustrative examples, the gas can include air. In one or more additional examples, the gap can have a thickness no greater than 3 mm. In at least some examples, the substrate can be coupled with the additional substrate using one or more adhesives. For example, the substrate can be coupled to the additional substrate using an optically clear adhesive. In one or more additional examples, the substrate can be coupled to the additional substrate using one or more packages or one or more mechanical coupling devices.

Additionally, at 410, the process 400 can include producing a device that comprises a plurality of substrate that includes at least the substrate and the additional substrate. In one or more examples, the device can redirect the path of electromagnetic radiation incident on the device by at least 20 degrees. In one or more illustrative examples, the electromagnetic radiation incident on the device can have frequencies of at least 20 GHz. In various examples, the device can include an antenna that transmits electromagnetic radiation of a communications system. In one or more additional examples, the device can include a transmitarray. In one or more further examples, the device can include a reflectarray. In still other examples, the device can include a reconfigurable intelligent surface. In various examples, the device can include a reflective frequency selective surface that is used to redirect electromagnetic radiation within an indoor environment. The device can also include a reflective frequency selective surface to redirect electromagnetic radiation in an outdoor environment. In at least some examples, the device can include a transmission frequency selective surface to redirect electromagnetic radiation from an outdoor environment into an indoor environment.

In situations where the device includes a reflectarray, a portion of incident electromagnetic radiation on the first surface reflects at the first surface and a remainder of the incident electromagnetic radiation on the first surface propagates toward the second surface and reflects at the second surface. In various examples, a reflection of the electromagnetic radiation at the first surface with respect to a total reflection is at least 50%, at least 60%, at least 70%, at least 80%, or at least 90%.

Process 400 may include additional implementations, such as any single implementation or any combination of implementations described below and/or in connection with one or more other processes described elsewhere herein.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

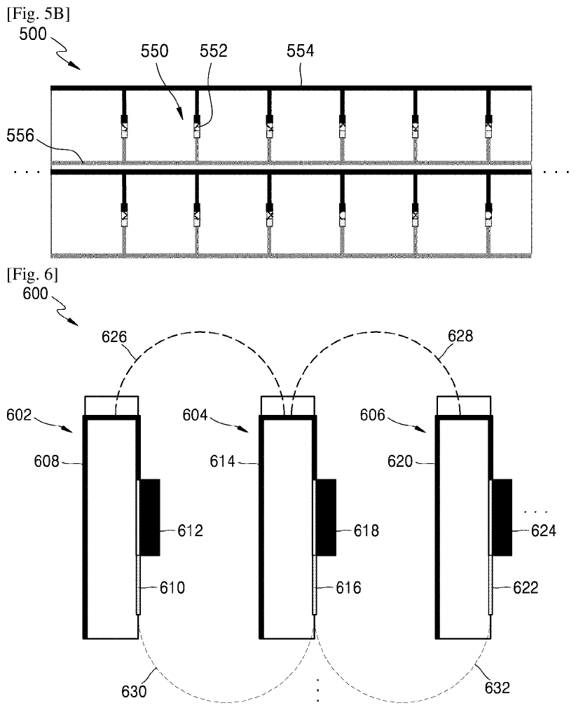

FIG. 5A illustrates an orthogonal view of unit cells of a metasurface 500 of a transmitarray to direct the path of electromagnetic radiation, according to one or more implementations. The metasurface 500 can include a first unit cell 502 and a second unit cell 504. The first unit cell 502 can include a first active component 506 and the second unit cell 504 can include a second active component 508. In one or more illustrative examples, the first active component 506 and the second active component 508 can include a varactor. The metasurface 500 can also include a first electrical connector 510 and a second electrical connector 512. The first electrical connector 510 can be configured to deliver at least one of a first voltage or a first current to the active components 506, 508. In one or more examples, the first electrical connector 510 can provide one or more first biasing conditions to the active components 506, 508. Additionally, the second electrical connector 512 can be configured to deliver at least one of a second voltage or a second current to the active components 506, 508. In various examples, the second electrical connector 512 can provide one or more second biasing conditions to the active components 506, 508.

FIG. 5B illustrates a top view of the metasurface 500 of the transmitarray to direct the path of electromagnetic radiation, according to one or more implementations. The metasurface 500 includes a pattern of unit cells. The pattern of unit cells can include a number of individual unit cells, such as representative unit cell 550. Individual unit cells can include one or more active components, such as representative active component 552. The unit cells can be coupled to one or more electrical connectors to cause one or more electrical states of the unit cells. For example, the metasurface 500 can include a representative first electrical connector 554 to cause one or more first biasing conditions with respect to active components coupled to the first electrical connector 554. Additionally, a representative second electrical connector 556 to cause one or more second biasing conditions with respect to active components coupled to the second electrical connector 556.

FIG. 6 illustrates a device 600 including multiple metasurfaces to direct the path of electromagnetic radiation, according to one or more implementations. The individual metasurfaces include a pattern of unit cells in which individual varactors are located. In one or more examples, spacers can be present to produce air gaps between glass metasurfaces.

In the illustrative example of FIG. 6, the device 600 can include a first metasurface 602, a second metasurface 604, and a third metasurface 606. Patterns of can be formed on surfaces of the individual metasurfaces. In one or more examples, the patterns can be formed from one or more conductive materials. In one or more additional examples, the patterns can be formed from one or more polymeric materials. In one or more further examples, the patterns can be formed from one or more semiconductor materials. In the illustrative example of FIG. 6, the first metasurface 602 can include a first pattern 608 and a second pattern 610 that can be different from the first pattern 608. The first metasurface 602 can also include one or more active components 612. The second metasurface 604 can also include a first pattern 614 and a second pattern 616 that is different from the first pattern 614. Additionally, the second metasurface can include one or more active components 618. Further, the third metasurface 606 can include a first pattern 620 and a second pattern 622 as well as an active component 624.

In one or more examples, at least a portion of the first patterns 608, 614, 620 can be formed on a same surface as the second patterns 610, 616, 622. In various examples, the first patterns 608, 614, 620 can be formed on both top surfaces and a portion of bottom surfaces of the metasurfaces 602, 604, 606 and the second patterns 610, 616, 622 can be formed on an additional portion of the bottom surfaces of the metasurfaces 602, 604, 606.

The device 600 can also include one or more first electrical connectors 626, 628 to deliver at least one of a specified voltage or current to the active components 612, 618, 624. For example, the first electrical connector 626 can be coupled to the first metasurface 602 and the second metasurface 604 to provide a first biasing condition and the additional first electrical connector 628 can be coupled to the second metasurface 604 and the third metasurface 606 to provide the first biasing condition. Additionally, the device 600 can include second electrical connectors 630, 632 to deliver at least one of a specified voltage or current to the active components 612, 618, 624. For example, the second electrical connector 630 can be coupled to the first metasurface 602 and the second metasurface 604 to provide a second biasing condition and the additional second electrical connector 632 can be coupled to the second metasurface 604 and the third metasurface 606 to provide the second biasing condition.

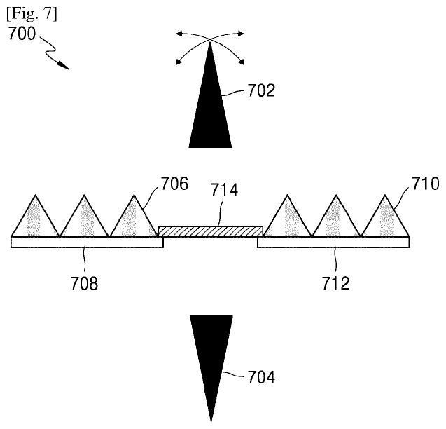

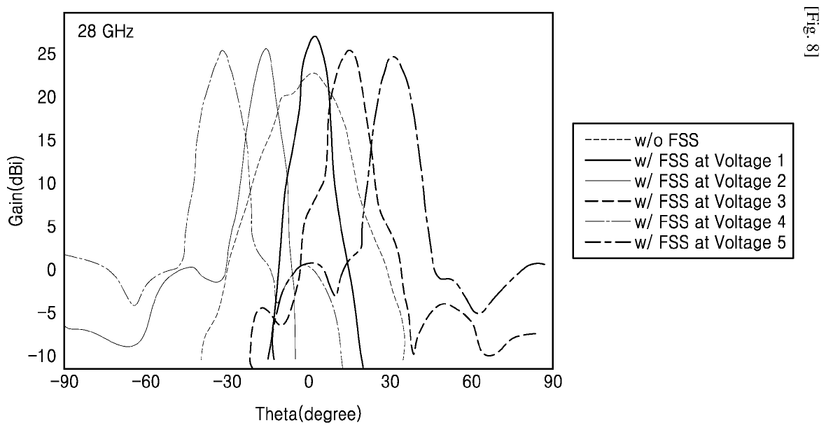

FIG. 7 illustrates a measurement system 700 to determine an amount of phase shift produced in response to electromagnetic radiation being incident on the device shown in FIG. 6, according to one or more implementations. The measurement system 700 can include a receiving horn antenna 702 and a transmission horn antenna 704. The receiving horn antenna 702 can be disposed opposite the transmission horn antenna 704. The measurement system 700 can also include a first set of absorbers 706 disposed on a first metallic substrate 708 and a second set of absorbers 710 disposed on a second metallic substrate 712. A frequency selective surface 714 can be disposed on the first metallic surface 708 and the second metallic surface 712 between the first set of absorbers 706 and the second set of absorbers 710. In various examples, at least one of the receiving horn antenna 702 or the transmission horn antenna 704 can be rotatable.

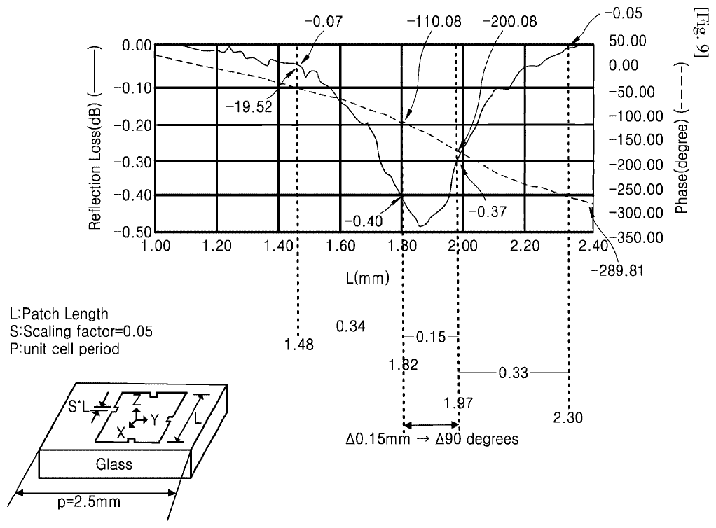

FIG. 8 illustrates measurements of gain without and without the device of FIG. 6. The gain is measured for electromagnetic radiation having wavelengths of 28 GHz as different voltages are applied to the device of FIG. 6.

FIG. 9 illustrates reflection loss for a device having a glass substrate with a number of unit cells formed on the glass substrate in relation to the path length of a pattern included in the unit cell. In the illustrative example of FIG. 9, the wavelength of electromagnetic radiation being directed is 28 GHz and the width of an individual unit cell is 2.5 mm.

Some implementations are described as numbered examples (Example 1, 2, 3, etc.). These are provided as examples only and do not limit the technology disclosed herein.
Example 1. A device comprising: one or more substrates, individual substrates of the one or more substrates comprising a glass material and the substrate including a first surface and a second surface disposed opposite the first surface; and a layer of metal disposed on the first surface according to a pattern that includes a number of elements, wherein electromagnetic radiation incident on the first surface at a first angle is redirected at a second angle, and the electromagnetic radiation has a frequency of at least twenty gigahertz (GHz).
Example 2. The device of example 1, where the individual substrates have a Young's modulus of at least 30 gigapascals (GPa) and a thickness from 0.2 mm to 0.6 mm.
Example 3. The device of example 1 or 2, wherein the individual substrates have a relative permittivity from 4.0 Farads/meter (F/m) to 6.0 F/m and an optical transparency of at least 90%.
Example 4. The device of any one of examples 1-3, wherein the electromagnetic radiation is incident on the first surface and redirected at the second angle through the second surface.
Example 5. The device of any one of examples 1-4, wherein a portion of incident electromagnetic wave on the first surface reflects at the first surface and a remainder of the incident electromagnetic wave on the first surface propagates toward the second surface and reflects at the second surface, and wherein a reflection of the electromagnetic wave at the first surface with respect to a total reflection is at least 50%.
Example 6. The device of any one of examples 1-5, wherein a measure of surface roughness of the substrate is no greater than 0.4 mm.
Example 7. The device of any one of examples 1-6, wherein the pattern includes a number of unit cells and individual unit cells of the number of unit cells include a feature formed by a layer of metal disposed in the individual unit cells.
Example 8. The device of example 7, wherein the feature is formed according to a Minkowski fractal pattern, a Koch snowflake pattern, a Hilbert curve pattern, or a cross fractal pattern.
Example 9. The device of example 7, wherein the pattern includes at least one of one or more varactors, one or more pin diodes, one or more transistors, one or more micro electro-mechanical systems (MEMS), one or more ferroelectric films, or one or more graphene-based features.
Example 10. The device of any one of examples 1-9, wherein the pattern is formed from a metallic material that includes at least one of copper, titanium, or aluminum and the glass material comprises at least 50 mole % silica on an oxide basis.
Example 11. The device of any one of examples 1-10, wherein: an additional layer of metal is disposed on the second surface according to an additional pattern that includes a number of additional elements; and the individual substrates include a number of vias to couple the number of elements of the layer of metal disposed on the first surface with the additional number of elements of the additional layer of metal disposed on the second surface.
Example 12. The device of example 11, wherein a width of individual vias of the number of vias is greater than a height of the layer of metal and an additional height of the additional layer of metal.
Example 13. The device of example 12, wherein the height of the layer of metal is no greater than 0.5 micrometers.
Example 14. A communications device comprising: a first substrate comprised of a glass material and having a layer of metal disposed on at least one surface of the first substrate according to a pattern that includes a number of elements, wherein electromagnetic radiation incident on the at least one surface at a first angle is redirected at a second angle, and the electromagnetic radiation has a frequency of at least twenty gigahertz (GHz); a second substrate comprised of a glass material and having an additional layer of metal disposed on at least one surface of the second substrate according to the pattern, wherein electromagnetic radiation incident on the at least one surface at a first additional angle is redirected at a second additional angle; and a gap disposed between the first substrate and the second substrate, wherein the gap has a thickness of from 1.5 mm to 4 mm.
Example 15. The communications device of example 14, wherein the total reflection coefficient with respect to the first substrate and the second substrate is no greater than 0.7.
Example 16. The communications device of example 14 or 15, wherein the first substrate and the second substrate are components of an antenna.
Example 17. The communications device of any one of examples 14-16, wherein the first substrate and the second substrate are components of a reflectarray.
Example 18. The communications device of any one of examples 14-17, wherein the first substrate and the second substrate are components of a reconfigurable intelligent surface.
Example 19. A process comprising: providing a substrate comprising a glass material having a Young's modulus of at least 30 GPa, a thickness from 0.2 mm to 0.6 mm, and a relative permittivity from 4.0 F/m to 6.0 F/m; forming a first pattern on a first surface of the substrate by depositing a first layer of metal on the first surface; forming a second pattern on a second surface of the substrate by depositing a second layer of the metal on the second surface; coupling the substrate with an additional substrate comprising the glass material such that a gap is disposed between the substrate and the additional substrate, wherein the gap has a thickness of from 1.5 mm to 4 mm; and producing a device that comprises a plurality of substrates that include at least the substrate and the additional substrate, wherein the device redirects the path of electromagnetic radiation incident on the device by at least 25 degrees, and wherein the electromagnetic radiation has frequencies of at least 20 GHz.
Example 20. The process of example 19, wherein: the first pattern is formed on the first surface by performing a first sputtering process to deposit the first layer of metal onto the first surface; and the second pattern is formed on the second surface by performing a second sputtering process to deposit the second layer of metal onto the second surface.
Example 21. The process of example 19 or 20, wherein: the first pattern is formed on the first surface by performing a first electron beam deposition process to deposit the first layer of metal onto the first surface; and the second pattern is formed on the second surface by performing a second electron beam deposition process to deposit the second layer of metal onto the second surface.
Example 22. The process of any one of examples 19-21, comprising: forming one or more vias in the substrate using one or more laser projection processes and one or more chemical etching processes, wherein the one or more vias include a conductive material that electrically couples one or more features of the first layer of metal disposed on the first surface with one or more features of the second layer of metal disposed on the second surface.

Although one or more implementations have been described with reference to specific example implementations, it will be evident that various modifications and changes may be made to these implementations without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific implementations in which the subject matter may be practiced. The implementations illustrated are described in sufficient detail to enable those skilled in the art to practice the teachings disclosed herein. Other implementations may be utilized and derived therefrom, such that structural and logical substitutions and changes may be made without departing from the scope of this disclosure. This Detailed Description, therefore, is not to be taken in a limiting sense, and the scope of various implementations is defined only by the appended claims, along with the full range of equivalents to which such claims are entitled.

Although specific implementations have been illustrated and described herein, it should be appreciated that any arrangement calculated to achieve the same purpose may be substituted for the specific implementations shown. This disclosure is intended to cover any and all adaptations or variations of various implementations. Combinations of the above implementations, and other implementations not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single implementation for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separate implementations.

What is claimed is:

1. A device comprising:
one or more substrates, individual substrates of the one or more substrates comprising a glass material and the substrate including a first surface and a second surface disposed opposite the first surface; and
a layer of metal disposed on the first surface according to a pattern that includes a number of elements, wherein electromagnetic radiation incident on the first surface at a first angle is redirected at a second angle, and the electromagnetic radiation has a frequency of at least twenty gigahertz (GHz).

2. The device of claim 1, where the individual substrates have a Young's modulus of at least 30 gigapascals (GPa) and a thickness from 0.2 mm to 0.6 mm.

3. The device of claim 1, wherein the individual substrates have a relative permittivity from 4.0 Farads/meter (F/m) to 6.0 F/m and an optical transparency of at least 90%.

4. The device of claim 1, wherein the electromagnetic radiation is incident on the first surface and redirected at the second angle through the second surface.

5. The device of claim 1, wherein a portion of incident electromagnetic wave on the first surface reflects at the first surface and a remainder of the incident electromagnetic wave on the first surface propagates toward the second surface and reflects at the second surface, and wherein a reflection of the electromagnetic wave at the first surface with respect to a total reflection is at least 50%.

6. The device of claim 1, wherein a measure of surface roughness of the substrate is no greater than 0.4 mm.

7. The device of claim 1, wherein the pattern includes a number of unit cells and individual unit cells of the number of unit cells include a feature formed by a layer of metal disposed in the individual unit cells.

8. The device of claim 7, wherein the feature is formed according to a Minkowski fractal pattern, a Koch snowflake pattern, a Hilbert curve pattern, or a cross fractal pattern.

9. The device of claim 7, wherein the pattern includes at least one of one or more varactors, one or more pin diodes, one or more transistors, one or more micro electromechanical systems (MEMS), one or more ferroelectric films, or one or more graphene-based features.

10. The device of claim 1, wherein the pattern is formed from a metallic material that includes at least one of copper, titanium, or aluminum and the glass material comprises at least 50 mole % silica on an oxide basis.

11. The device of claim 1, wherein:
an additional layer of metal is disposed on the second surface according to an additional pattern that includes a number of additional elements; and
the individual substrates include a number of vias to couple the number of elements of the layer of metal disposed on the first surface with the additional number of elements of the additional layer of metal disposed on the second surface.

12. The device of claim 11, wherein a width of individual vias of the number of vias is greater than a height of the layer of metal and an additional height of the additional layer of metal.

13. The device of claim 12, wherein the height of the layer of metal is no greater than 0.5 micrometers.

14. A communications device comprising:
a first substrate comprised of a glass material and having a layer of metal disposed on at least one surface of the first substrate according to a pattern that includes a number of elements, wherein electromagnetic radiation incident on the at least one surface at a first angle is redirected at a second angle, and the electromagnetic radiation has a frequency of at least twenty gigahertz (GHz);
a second substrate comprised of a glass material and having an additional layer of metal disposed on at least one surface of the second substrate according to the pattern, wherein electromagnetic radiation incident on the at least one surface at a first additional angle is redirected at a second additional angle; and
a gap disposed between the first substrate and the second substrate, wherein the gap has a thickness of from 1.5 mm to 4 mm.

15. The communications device of claim 14, wherein the total reflection coefficient with respect to the first substrate and the second substrate is no greater than 0.7.

16. The communications device of claim 14, wherein the first substrate and the second substrate are components of an antenna.

17. The communications device of claim 14, wherein the first substrate and the second substrate are components of a reflectarray.

18. The communications device of claim 14, wherein the first substrate and the second substrate are components of a reconfigurable intelligent surface.

19. A process comprising:
providing a substrate comprising a glass material having a Young's modulus of at least 30 GPa, a thickness from 0.2 mm to 0.6 mm, and a relative permittivity from 4.0 F/m to 6.0 F/m;
forming a first pattern on a first surface of the substrate by depositing a first layer of metal on the first surface;
forming a second pattern on a second surface of the substrate by depositing a second layer of the metal on the second surface;
coupling the substrate with an additional substrate comprising the glass material such that a gap is disposed between the substrate and the additional substrate, wherein the gap has a thickness of from 1.5 mm to 4 mm; and
producing a device that comprises a plurality of substrates that include at least the substrate and the additional substrate, wherein the device redirects the path of electromagnetic radiation incident on the device by at least 25 degrees, and wherein the electromagnetic radiation has frequencies of at least 20 GHz.

20. The process of claim 19, wherein:
the first pattern is formed on the first surface by performing a first sputtering process to deposit the first layer of metal onto the first surface; and
the second pattern is formed on the second surface by performing a second sputtering process to deposit the second layer of metal onto the second surface.

21. The process of claim 19, wherein:
the first pattern is formed on the first surface by performing a first electron beam deposition process to deposit the first layer of metal onto the first surface; and
the second pattern is formed on the second surface by performing a second electron beam deposition process to deposit the second layer of metal onto the second surface.

22. The process of claim 19, comprising:
forming one or more vias in the substrate using one or more laser projection processes and one or more chemical etching processes, wherein the one or more vias include a conductive material that electrically couples one or more features of the first layer of metal disposed on the first surface with one or more features of the second layer of metal disposed on the second surface.
